(19) United States
(12) Patent Application Publication
(10) Pub. No.: US 2021/0306846 A1
(43) Pub. Date: Sep. 30, 2021

(54) ACCESSORY DEVICE PAIRING

(71) Applicant: Lenovo (Singapore) Pte. Ltd., Singapore (SG)

(72) Inventors: Philip John Jakes, Durham, NC (US); Hidetoshi Mori, Kanagawa-ken (JP); Jonathan Daniel Pollock, Cary, NC (US); James Christopher Salembier, Cary, NC (US)

(21) Appl. No.: 16/836,257

(22) Filed: Mar. 31, 2020

(51) Int. Cl. H04W 12/00; H04W 4/80; H04W 4/20

(52) U.S. Cl. CPC H04W 12/003; H04W 4/203; H04W 4/80

(57) ABSTRACT

One embodiment provides a method, including: receiving, at an accessory device, an indication to initiate a pairing process with an information handling device; adjusting, responsive to the receiving, a transmitting power of the accessory device; and pairing, based on the adjusting, the accessory device to the information handling device. Other aspects are described and claimed.

### BACKGROUND

Users frequently utilize at least one accessory device (e.g., a keyboard, a mouse, a stylus, a headset, etc.) in conjunction with their information handling devices (“devices”, “user computing devices”, etc.), for example, smart phones, tablets, laptops and/or personal computers, and the like. As technology has progressed, accessory devices have been developed that are capable of establishing a wireless connection with the user devices. Such a capability enables users to easily transport their accessory devices from place to place and to pair them with a variety of different user devices.

### BRIEF SUMMARY

In summary, one aspect provides a method, comprising: receiving, at an accessory device, an indication to initiate a pairing process with an information handling device; adjusting, responsive to the receiving, a transmitting power of the accessory device; and pairing, based on the adjusting, the accessory device to the information handling device.

Another aspect provides an accessory device, comprising: a processor; a memory device that stores instructions executable by the processor to: receive an indication to initiate a pairing process with an information handling device; adjust, responsive to the receiving, a transmitting power of the accessory device; and pairing, based on the adjusting, the accessory device to the information handling device.

A further aspect provides a product, comprising: a storage device that stores code, the code being executable by a processor and comprising: code that receives an indication to pair an accessory device with an information handling device; code that adjusts, responsive to the receiving, a transmitting power of the accessory device; and code that pairs, based on the adjusting, the accessory device to the information handling device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of pairing an accessory device with an information handling device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A variety of automatic pairing applications exist that enable easier pairing of accessory devices with various user computing devices. At a high level, many of these applications operate by receiving, at a computing device, a pairing request from an accessory device. The pairing request may be broadcast from the accessory device to all surrounding computing devices within a predetermined beaconing range of the accessory device (e.g., 15 meter range, 30 meter range, etc.). Upon detection of the pairing request, a computing device may query a user whether they want to pair the accessory device to the computing device or, alternatively, may automatically facilitate a pairing process with the accessory device.

Although the foregoing pairing applications are successful in reaching a large pool of viable computing devices, the large net cast by these existing processes may be problematic in certain contexts. For example, in an open office environment a pairing request from an accessory device may be detected by a plurality of computing devices. At best, receipt of such a pairing request may be annoying to the users of computing devices not intended to be paired to the accessory device (e.g., if each of the computing devices provides a pop-up notification indicating that a pairable device is requesting to be paired, etc.). At worst, a user of an unintended computing device may accidently or maliciously accept the pairing request and take control of the accessory device, thereby causing confusion and/or security issues.

Accordingly, an embodiment provides a method for dynamically pairing an accessory device with a particular computing device without pairing, or providing pairing notifications, to other unintended computing devices. In an embodiment, an indication to initiate a pairing process with a device may be received at an accessory device. An embodiment may then adjust a transmitting power of the accessory device (e.g., from a default transmitting power to a lower transmitting power, etc.) and thereafter pair the accessory device to the device while operating at the adjusted transmitting power. If pairing at this stage cannot be accomplished (e.g., because the transmitting power of the accessory device is too low for the distance separating the accessory device and the intended device, etc.) then an embodiment may dynamically increase the transmitting power in stepped adjustments until pairing is achieved. Such a method limits or prevents the instances of unintended pairing with other devices.

The illustrated example embodiments will be best understood by reference to the figures. The following description is intended only by way of example, and simply illustrates certain example embodiments.

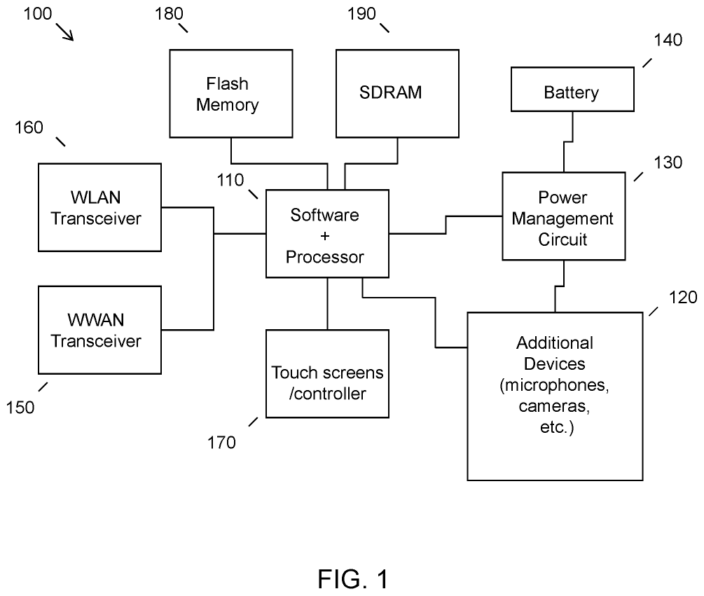

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

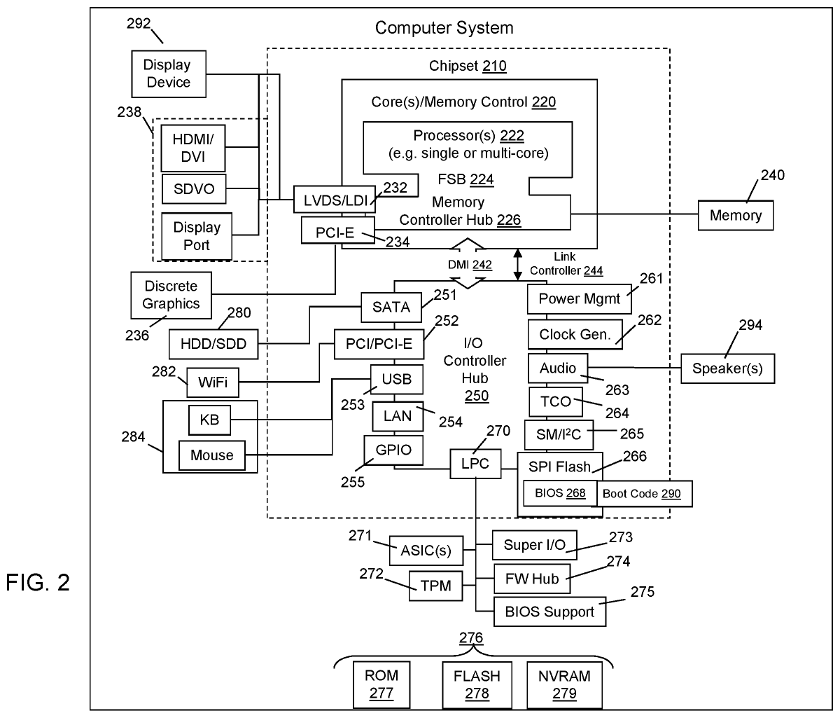

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Accessory devices described herein may connect and/or pair to computing devices having circuitry, as for example outlined in FIG. 1 or FIG. 2, used for facilitating a wireless pairing process with an accessory device. For example, the circuitry outlined in FIG. 1 may be implemented in a smart phone or tablet embodiment, whereas the circuitry outlined in FIG. 2 may be implemented in a laptop.

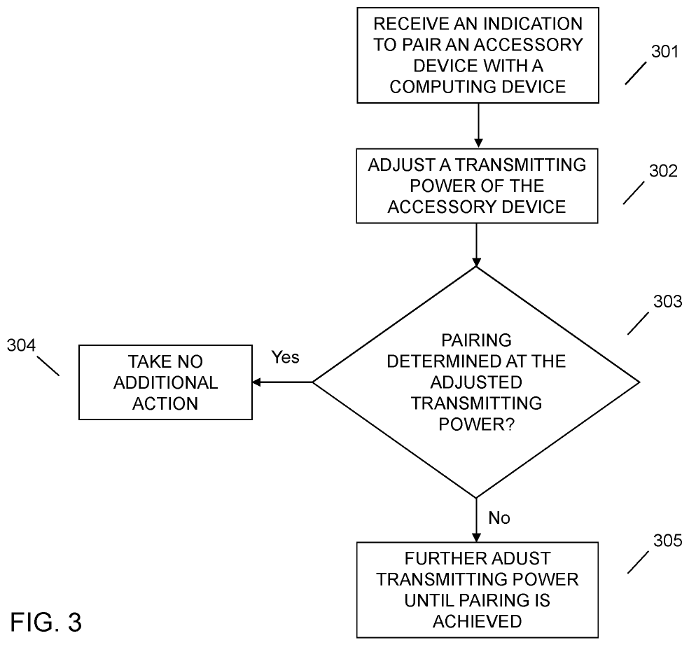

Referring now to FIG. 3, an embodiment provides a method for dynamically pairing an accessory device with a user computing device. At 301, an embodiment may receive an indication at an accessory device to initiate a pairing process with a computing device. In an embodiment, the accessory device may be virtually any device that is capable of connecting to and/or pairing with a computing device. For instance, non-limiting examples of conventional accessory devices include keyboards, mouse, styli, headsets, gaming controllers, headsets, etc.

In an embodiment, the indication to initiate pairing may derive from an express user pairing input. For example, a user may actuate a dedicated pairing button on the accessory device that correspondingly sends a pairing request signal to computing devices within a beaconing range of the accessory device. Alternatively, in another embodiment, the indication may be derived from an automatic pairing process. For example, an embodiment may automatically send a pairing request upon detection of a predetermined criterion (e.g., upon detection of an accessory device being turned on, an accessory device entering a certain location, etc.).

At 302, an embodiment may dynamically adjust a transmitting power of the accessory device responsive to receipt of the indication. In an embodiment, the adjustment of the transmitting power may be automatic and may not require any additional user input. In an embodiment, the transmitting power of the accessory device may dictate the physical range, or distance, that the pairing request signal may be transmitted. In an embodiment, the adjustment of the transmitting power may correspond to an adjustment of the transmitting power from a default transmitting power to a lower transmitting power. The lower transmitting power may correspond to a predetermined lower transmitting power. Such a predetermined transmitting power may be originally established by a manufacturer and/or may be later adjusted by a user (e.g., by toggling device settings, etc.). For example, the predetermined lower transmitting power may be the lowest transmitting power setting available to the device.

Alternatively, the predetermined transmitting power level may be dynamically learned over time. For example, an embodiment may identify that a user manually adjusts the transmitting power of the accessory device to a particular transmitting power each time they try to initiate a pairing process with a particular computing device. From this knowledge, an embodiment may dynamically adjust the default transmitting power to the predetermined transmitting power when a predetermined criterion is detected (e.g., when the particular computing device is detected to be within proximity to the accessory device, when the accessory device is detected to be in a same location as the computing device, etc.). In another embodiment, the accessory device may comprise one or more sensors that may aid in the dynamic adjustment of the transmitting power. For example, in an embodiment, an accessory device may contain an integrated camera sensor that may be able to identify a computing device and, using one or more conventional image analysis techniques, determine a distance to that computing device from the accessory device. An embodiment may thereafter utilize this distance knowledge to adjust a transmitting power of the accessory device to accommodate the determined distance.

At 303, an embodiment may attempt to pair the accessory device to a user computing device at the adjusted transmitting power. More particularly, an embodiment may transmit a pairing request to any user computing devices within a range dictated by the transmitting power at the adjusted setting. Responsive to determining, at 303, that pairing was achieved at the adjusted transmitting power, an embodiment may, at 304, take no additional action. Additionally or alternatively, an embodiment may provide a notification to a user that pairing was achieved (e.g., an audible and/or visual notification originating from either of the accessory device or the user computing device, etc.). Conversely, responsive to determining, at 303, that pairing could not be achieved at the adjusted transmitting power, an embodiment may, at 305, further adjust the transmitting power until pairing is achieved.

With respect to the foregoing, an embodiment may gradually increase the adjusted transmitting power to a greater transmitting power until pairing is achieved. For example, an embodiment may first attempt to pair with a computing device at the lowest transmitting power (i.e., assuming that the lowest transmitting power corresponds to the adjusted transmitting power). If pairing is unsuccessful (e.g., because a computing device is not within a broadcast range of the accessory device operating at the lowest transmitting power, etc.), an embodiment may thereafter raise the transmitting power by a predetermined amount. For example, an embodiment may raise the transmitting power by one power level, which correspondingly affects the range that a pairing request may be broadcast. This process may be repeated until a successful pairing is achieved. It is important to note that the foregoing techniques may also be applicable to situations where the transmitting power of the accessory device is lowered to a predetermined transmitting power that is lower than a default transmitting power but higher than the lowest transmitting power.

The various embodiments described herein thus represent a technical improvement to conventional methods for pairing an accessory device to a user computing device. In an embodiment, an indication may be received to initiate a pairing process with a computing device. An embodiment may then adjust a transmitting power of the accessory device (e.g., from a default transmitting power to a lower transmitting power, etc.) and attempt to pair with a computing device at this adjusted lower transmitting power. If pairing is unsuccessful, an embodiment may gradually increase the transmitting power of the accessory device until pairing between the accessory device and a user computing device can be achieved. Such a method may reduce the number of unintended computing devices that may be disturbed by broadcasted pairing requests.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at an accessory device, an indication to initiate a pairing process with an information handling device;
capturing, using an integrated camera sensor of the accessory device, an image of an area containing the information handling device;
identifying, upon analysis of the image, a distance from the accessory device to the information handling device;
adjusting, responsive to the receiving, a transmitting power for a pairing request from the accessory device by a predetermined amount, wherein the predetermined amount is based on the identified distance;
determining, using a processor, whether a pairing event between the accessory device and the information handling device is achieved at the adjusted transmitting power;
increasing, responsive to determining that the pairing event between the accessory device and the information handling device is not achieved at the adjusted transmitting power, the transmitting power, wherein the increasing comprises:
accessing historical adjustment data for the transmitting power between the accessory device and the information handling device;
identifying, in the historical adjustment data, a common level for the transmitting power; and
dynamically increasing the transmitting power to the common level; and
pairing, based on the increasing adjusting, the accessory device to the information handling device.

2. The method of claim 1, wherein the accessory device is a device selected from the group consisting of a keyboard, a mouse, a stylus, and a headset.

3. The method of claim 1, wherein the receiving the indication comprises receiving a user input to initiate the pairing process.

4.-9. (canceled)

10. The method of claim 1, wherein the adjusting comprises automatically adjusting without receiving any additional user input.

11. An accessory device, comprising:
a processor;
a memory device that stores instructions executable by the processor to:
receive an indication to initiate a pairing process with an information handling device;
capture, using an integrated camera sensor of the accessory device, an image of an area containing the information handling device;
identify, upon analysis of the image, a distance from the accessory device to the information handling device;
adjust, responsive to the receiving, a transmitting power for a pairing request from the accessory device by a predetermined amount, wherein the predetermined amount is based on the identified distance;
determine, using a processor, whether a pairing event between the accessory device and the information handling device is achieved at the adjusted transmitting power;
increase, responsive to determining that the pairing event between the accessory device and the information handling device is not achieved at the adjusted transmitting power, the transmitting power, wherein the instructions executable by the processor to increase comprise instructions executable by the processor to:
access historical adjustment data for the transmitting power between the accessory device and the information handling device;
identify, in the historical adjustment data, a common level for the transmitting power; and
dynamically increase the transmitting power to the common level; and
pair, based on the increasing, the accessory device to the information handling device.

12. The accessory device of claim 11, wherein the accessory device is a device selected from the group consisting of a keyboard, a mouse, a stylus, and a headset.

13. The accessory device of claim 11, wherein the instructions executable by the processor to receive the indication comprise instructions executable by the processor to receive a user input to initiate the pairing process.

14.-19. (canceled)

20. A product, comprising:
a storage device that stores code, the code being executable by a processor and comprising:
code that receives an indication to pair an accessory device with an information handling device;
code that captures, using an integrated camera sensor of the accessory device, an image of an area containing the information handling device;
code that identifies, upon analysis of the image, a distance from the accessory device to the information handling device;
code that adjusts, responsive to the receiving, a transmitting power for a pairing request from the accessory device by a predetermined amount, wherein the predetermined amount is based on the identified distance;
code that determines whether a pairing event between the accessory device and the information handling device is achieved at the adjusted transmitting power;
code that increases, responsive to determining that the pairing event between the accessory device and the information handling device is not achieved at the adjusted transmitting power, the transmitting power, wherein the code that increases comprises code that:
accesses historical adjustment data for the transmitting power between the accessory device and the information handling device;
identifies, in the historical adjustment data, a common level for the transmitting power; and
dynamically increases the transmitting power to the common level; and
code that pairs, based on the code that increases, the accessory device to the information handling device.
